(19) United States
(12) Patent Application Publication
(10) Pub. No.: US 2013/0147322 A1
(43) Pub. Date: Jun. 13, 2013

(54) SPINDLE MOTOR

(71) Applicant: LG INNOTEK CO., LTD., SEOUL (KR)

(72) Inventor: Chan Seok KIM, Seoul (KR)

(73) Assignee: LG INNOTEK CO., LTD., SEOUL (KR)

(21) Appl. No.: 13/711,087

(22) Filed: Dec. 11, 2012

(30) Foreign Application Priority Data
Dec. 12, 2011 (KR) 10-2011-0132680
Dec. 12, 2011 (KR) 10-2011-0132683

(51) Int. Cl. H02K 11/00; H02K 5/16

(52) U.S. Cl. CPC H02K 11/0068; H02K 5/165
USPC 310/67 R; 310/68 R

(57) ABSTRACT

A spindle motor is provided, the motor including a bearing assembly including a bearing housing accommodating a bearing, a stator coupled to an ambience of the bearing housing, a rotation shaft rotatably accommodated into the bearing, a rotor coupled to the rotation shaft to rotate in association with the stator, a base plate coupled to the bearing housing, and a circuit board arranged at an upper surface of the base plate to be electrically connected to the stator.

### CROSS-REFERENCE TO RELATED APPLICATIONS

This application claims the benefit under 35 U.S.C. §119 of Korean Patent Application Nos. 10-2011-0132680, filed Dec. 12, 2011, and 10-2011-0132683, filed Dec. 12, 2011, which are hereby incorporated by reference in their entirety.

### BACKGROUND

The present disclosure generally relates to a spindle motor.

An ODD (Optical Disk Drive) includes a spindle motor rotating an optical disk at a high speed, an optical pickup reading data from an optical disk or recording data on the optical disk, and a stepping motor moving an optical pickup module to a radial direction of a disk.

The spindle motor includes a bearing assembly including a bearing and a bearing housing, a stator fixed to the bearing housing and a rotor coupled to a rotation shaft inserted into the bearing. Furthermore, the spindle motor includes a base plate fixing the bearing housing, and a circuit board arranged on an upper surface of the base plate and electrically connected to the stator.

Generally, the base plate and the circuit board are mutually coupled using a double-sided tape for insulation and coupling. However, the coupling of the base plate to the circuit board using the double-sided tape in a conventional spindle motor requires a complex assembly process, and provides a difficulty in obtaining reliability in an environmental test under high temperature high humidity circumstances.

Furthermore, accurate and simultaneous assembly of base plate, double-sided tape and circuit board at a designated position make it difficult to obtain position accuracy and to mass-produce spindle motors. In addition, a heave (warpage or coplanarity) defect between the circuit board and the base plate may be generated by bending or warp of the circuit board after assembly of the base plate, the double-sided tape and the circuit board, and in order to inhibit the problem, a high bonding strength is required from the double-sided tape. On top of that, in a case the double-sided tape has a high bonding strength, it is difficult to re-use a high-priced circuit board due to high strength of adhesion.

A circuit board of a conventional spindle motor is arranged on a designated position of a base plate, and in a case an alignment defect is generated between the circuit board and the base plate, an alignment defect may be generated between a flexible circuit board of an optical disk drive and a circuit board of the spindle motor.

In order to align a base plate and a circuit board according to prior art, a through hole is formed at each of the base plate and the circuit board, an alignment pin formed on a jig is inserted by the base plate and the circuit board to align the base plate and the circuit board, where the base plate and the circuit board are mutually adhered using a double-sided tape.

However, even if the align pin is used to align the base plate and the circuit board, an alignment defect is frequently generated between the base plate and the circuit board due to manufacturing allowance of the alignment pin and allowance of the through hole formed on the base plate and the circuit board.

### BRIEF SUMMARY

Exemplary embodiments of the present disclosure provide a spindle motor configured to simplify assembly process by coupling a circuit board to a base plate free from a double-sided tape to obtain reliability in an environmental test, mass production of spindle motors is possible due to disuse of the double-sided tape, and a warpage (or heave) between the circuit board and the base plate can be inhibited to thereby allow re-using the circuit board.

The present invention provides a spindle motor configured to accurately align a base plate and a circuit board free from an alignment pin, thereby inhibiting an alignment defect between the base plate and the circuit board.

In one general aspect of the present disclosure, there is provided a spindle motor, the spindle motor comprising: a bearing assembly including a bearing housing accommodating a bearing; a stator coupled to an ambience of the bearing housing; a rotation shaft rotatably accommodated into the bearing; a rotor coupled to the rotation shaft to rotate in association with the stator; a base plate coupled to the bearing housing; and a circuit board arranged at an upper surface of the base plate to be electrically connected to the stator.

### BRIEF DESCRIPTION OF THE DRAWINGS

Accompanying drawings are included to provide a further understanding of arrangements and embodiments of the present disclosure and are incorporated in and constitute a part of this application. In the following drawings, like reference numerals refer to like elements and wherein:

FIG. 1 is a cross-sectional view of a spindle motor according to an exemplary embodiment of the present disclosure;

FIG. 2 is a plane view of a base plate of FIG. 1;

FIG. 3 is an enlarged view of ‘A’ part of FIG. 1;

FIG. 4 is an extracted plane view of a circuit board and a base plate of FIG. 1;

FIG. 5 is a cross-sectional view of a spindle motor according to another exemplary embodiment of the present disclosure;

FIG. 6 is an enlarged view of ‘B’ part of FIG. 5;

FIG. 7 is a plane view of a base plate of FIG. 1;

FIG. 8 is a cross-sectional view of an alignment unit cut along line ‘I-I’ of FIG. 7;

FIG. 9 is a cross-sectional view of FIG. 8 according to another exemplary embodiment of the present disclosure;

FIG. 10 is a plane view of a circuit board of FIG. 1;

FIG. 11 is a cross-sectional view cut along line ‘II-II’ of FIG. 10;

FIG. 12 is a plane view illustrating a base plate and a circuit board of FIG. 1;

FIG. 13 is a cross-sectional view cut along line ‘III-III’ of FIG. 12; and

FIG. 14 is a cross-sectional view of FIG. 13 according to another exemplary embodiment of the present disclosure

### DETAILED DESCRIPTION

### First Exemplary Embodiment

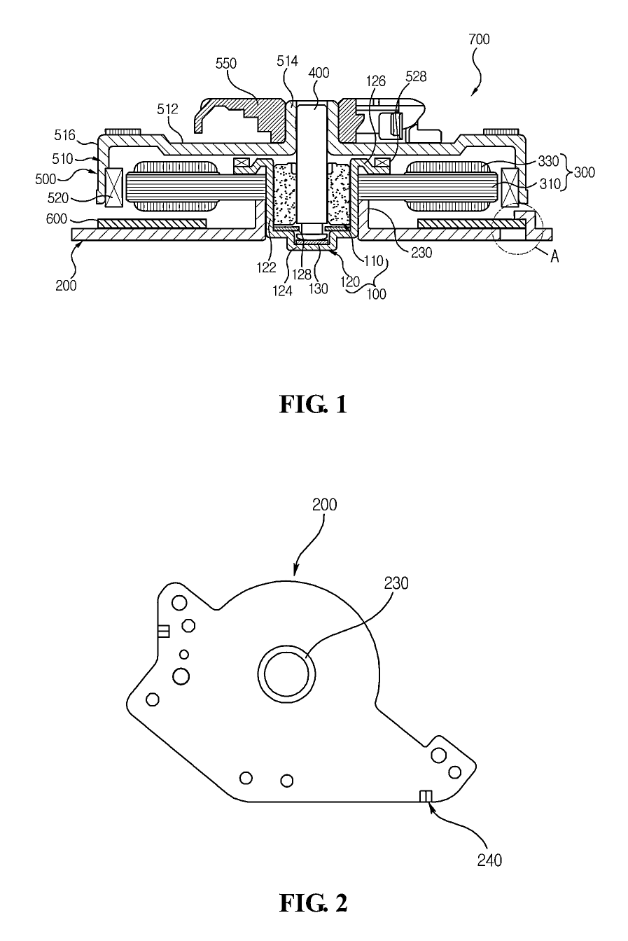

FIG. 1 is a cross-sectional view of a spindle motor (700) according to an exemplary embodiment of the present disclosure.

Referring to FIG. 1, the spindle motor (700) includes a bearing assembly (100), a stator (300), a rotation shaft (400), a rotor (500), a base plate (200) and a circuit board (600).

The bearing assembly (100) includes a bearing (110) and a bearing housing (120). The bearing (110) takes a shape of a circular cylinder having an outer surface and an inner surface opposite to the outer surface. The bearing (110) in an exemplary embodiment of the present disclosure may include an oil-impregnated sintered bearing. The inner surface of the bearing (110) is formed by a rotation shaft hole with an equal diameter, and rotationally supports the rotation shaft (400, described later).

The bearing housing (120) takes a shape of an upper surface-opened cylinder, and includes a lateral plate (122) and a floor plate (124). In addition, the bearing housing (120) may further include a washer (128) and a thrust bearing (130). The opened upper surface of the bearing housing (120) inserted by the bearing (110) is formed with a flange unit (126), where the flange unit (126) is extended from the upper surface of the bearing housing (120) to an upper surface of the stator (300, described later). The flange unit (126) depresses the stator (300) to inhibit the stator (300) from being deviated from the bearing housing (120). The flange unit (1260 may be arranged at an upper surface with a suction magnet (528) to inhibit the rotor (500, described later) from floating.

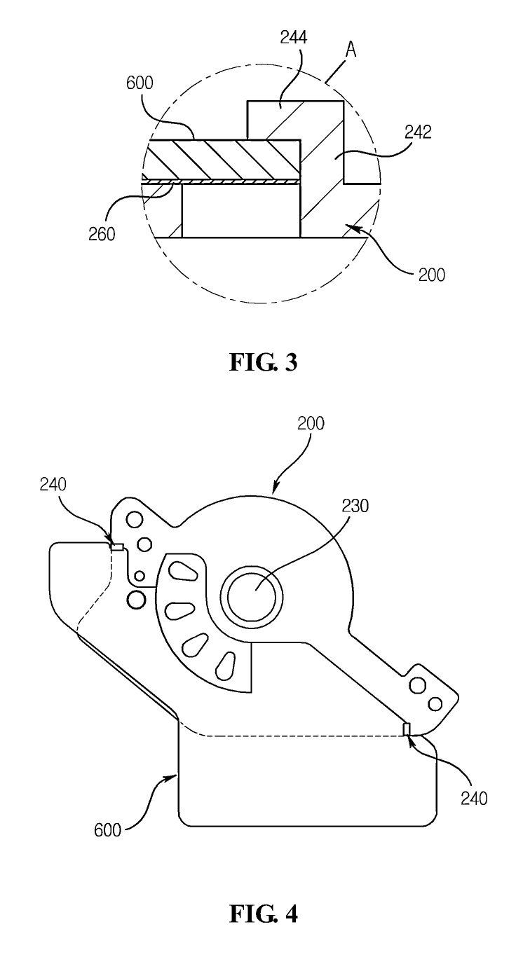

FIG. 2 is a plane view of a base plate of FIG. 1, and FIG. 3 is an enlarged view of ‘A’ part of FIG. 1.

Referring to FIGS. 1, 2 and 3, the base plate (200) is formed with a burring unit (230) for fixing an outer surface of the bearing housing (120). The base plate (200) is formed with at least one circuit board fixing unit (240) clamping an edge of a circuit board by cutting and bending a part of the base plate (200). The circuit board fixing unit (240) is preferably arranged at both sides of the burring unit (230) of the base plate (200) based on the burring unit (230). In an exemplary embodiment of the present disclosure, the circuit board fixing unit (240) includes a first fixing unit (242) and a second fixing unit (244).

The first fixing unit (242) is formed by cutting a part of the base plate (200) so as not to be completely separated from the base plate (200). The first fixing unit (242) is formed by cutting the base plate (200) in the shape of a ‘U’, and bending a cut portion upwards of the upper surface of the base plate (200), for example.

In an exemplary embodiment of the present disclosure, an angle formed by the first fixing unit (242) of the circuit board fixing unit (240) and the upper surface of the base plate (200) may be an obtuse angle. In a case the angle formed by the first fixing unit (242) of the circuit board fixing unit (240) and the upper surface of the base plate (200) exceeds 90°, an inner surface of the first fixing unit (242) may be partially brought into contact with a lateral surface of the circuit board (600, described later). On the other hand, in a case the angle formed by the first fixing unit (242) of the circuit board fixing unit (240) and the upper surface of the base plate (200) is perpendicular, the inner surface of the first fixing unit (242) may be totally brought into contact with the lateral surface of the circuit board (600, described later).

The second fixing unit (244) is formed by bending a part of the first fixing unit (242) in opposition to the circuit board (600), and the second fixing unit (244) may be brought into contact with an upper surface of the circuit board (600), for example.

In an exemplary embodiment of the present disclosure, a height formed between the upper surface of the base plate (200) and an upper surface of the second fixing unit (244) may be approximately 0.4 mm˜approximately 2 mm.

In an exemplary embodiment of the present disclosure, the first fixing unit (242) of the circuit board fixing unit (240) restricts movement of the circuit board (600) to a horizontal direction along the upper surface of the base plate (200) without a double-sided tape, and the second fixing unit (244) restricts movement of the circuit board (600) to a direction perpendicular to the upper surface of the base plate (200).

FIG. 4 is an extracted plane view of a circuit board and a base plate of FIG. 1.

Referring to FIG. 4, the circuit board (600) is arranged on the upper surface of the base plate (200), and fixed by the circuit board fixing unit (240) formed at the base plate (200). The circuit board (600) is arranged to a position of the base plate (200) designated by the circuit board fixing unit (240), and the circuit board (600) is fixed to the base plate (200) by the circuit board fixing unit (240) free from the double-sided tape.

Meanwhile, in a case the circuit board (600) is directly arranged on the upper surface of the conductive base plate (200), the circuit board (600) and the base plate (200) may be electrically short-circuited, such that an insulation member such as paper or synthetic resin film is arranged between the circuit board (600) and the base plate (200).

Referring to FIG. 1, the stator (300) is fixed to an outer surface of the bearing housing (120) fixed to the burring unit (230) of the base plate (200). The stator (300) includes a core (310) and a coil (330). The core (310) is formed by stacking a plurality of thin core pieces radially formed with a plurality of core units at an outer surface with a center opening formed thereon. The opening of the core (310) is press-fitted or coupled to the upper surface of the bearing housing (120). The coil (330) is wound on the core unit of the core (310), and the coil (330) is fixed to an upper surface (201) of the base plate (200).

The rotation shaft (400) is rotatably supported to the bearing (110) of the bearing assembly (100). The rotor (500) is coupled to an outer surface of the rotation shaft (400). The rotor (500) includes a yoke (510) and a magnet (520). The yoke (510) takes a shape of a bottom surface-opened cylinder, and includes a yoke upper plate (512) and a yoke lateral plate (516). A yoke burring unit (514) coupled to the outer surface of the rotation shaft (400) is formed at a rotational center of the yoke upper plate (512). The yoke lateral plate (516) is extended to a direction wrapping the core (310) from an edge of the yoke upper plate (512).

The magnet (520) is arranged along an inner lateral surface of the yoke lateral plate (516), and the magnet (516) is arranged opposite to the core (310). The yoke upper plate (512) is coupled at an upper surface to a centering unit (550) coupled to the yoke burring unit (514), where the centering unit (550) is coupled to an inner surface of the optical disk to align a rotation center of the optical disk to a rotation center of the rotation shaft (400).

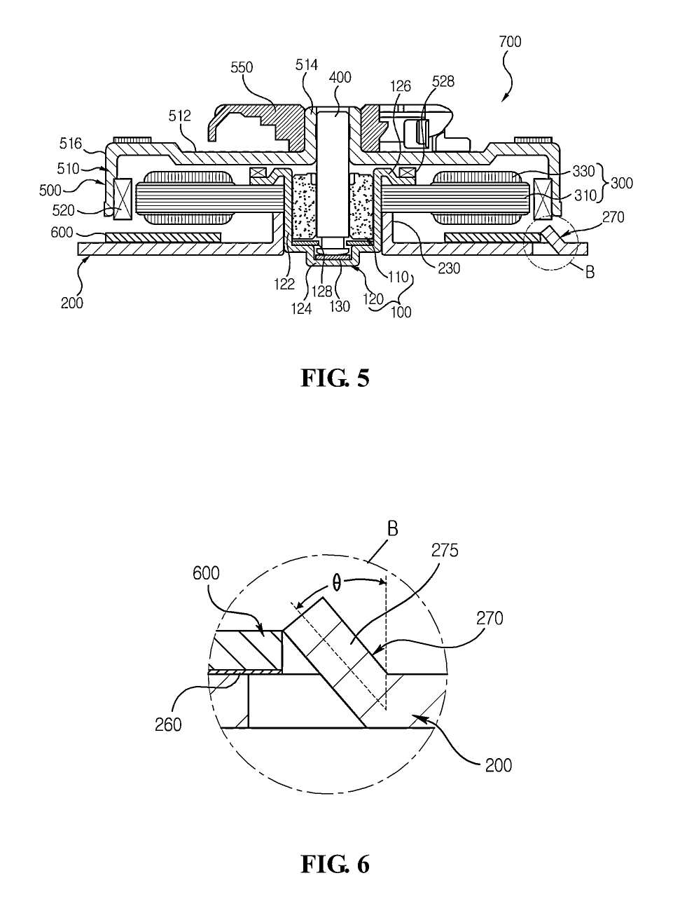

FIG. 5 is a cross-sectional view of a spindle motor according to another exemplary embodiment of the present disclosure, and FIG. 6 is an enlarged view of ‘B’ part of FIG. 5.

The spindle motor according to another exemplary embodiment of the present disclosure is substantially same as that illustrated and explained through FIGS. 1 to 4, except for a circuit board fixing unit. Thus, redundant explanation of same constituent elements will be omitted and like reference numerals refer to like elements in the same constituent elements.

Referring to FIGS. 5 and 6, the spindle motor (700) includes a bearing assembly (100), a stator (300), a rotation shaft (400), a rotor (500), a base plate (200) and a circuit board (600).

The base plate (200) is formed with a circuit board fixing unit (270). The circuit board fixing unit (270) includes a fixing unit (275) formed by cutting a part of the base plate (200) and bending the cut portion upwards of an upper surface of the base plate (200). The fixing unit (275) depresses a corner portion joined by an upper surface and a lateral surface of the circuit board (600) arranged on an upper surface of the base plate (200) to inhibit the circuit board (600) from vertically or vertically moving from the base plate (200).

In an exemplary embodiment of the present disclosure, an angle (A) formed by the fixing unit (275) of the circuit board fixing unit (270) and perpendicularity may be over 0° and less than 60°. In a case the angle (A) is 0°, it is difficult for the fixing unit (270) to depress the corner of the circuit board (600), and in a case the angle (A) is greater than 60°, a length of the fixing unit (275) is excessively lengthened to weaken a force to depress the circuit board (600).

### Second Exemplary Embodiment

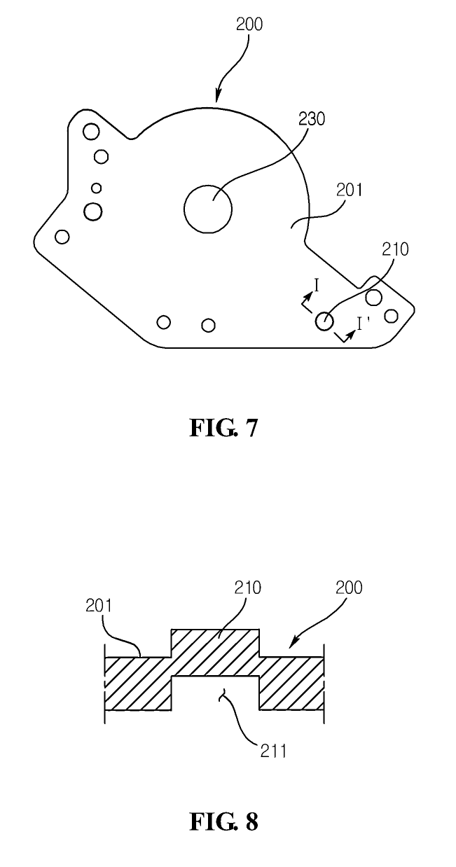

FIG. 7 is a plane view of a base plate of FIG. 1, and FIG. 8 is a cross-sectional view of an alignment unit cut along line ‘I-I’ of FIG. 7.

Referring to FIGS. 1, 7 and 8, a base plate (200) is fixed to an outer surface of a bearing housing (120) through a distal end of a bottom surface of the bearing housing (120) opposite to an upper distal end of the bearing housing (120) formed with a flange unit (126). The base plate (200) includes a burring unit (230) for fixing an outer surface of the bearing housing (120).

Meanwhile, the base plate (200) is also formed with at least two alignment units (210) each spaced apart at a predetermined distance. The alignment unit (210) serves to accurately align the circuit board (600, described later) and the base plate (200). At least two alignment units (210) are formed at the base plate (200), and each of the alignment units (210) is formed at a position spaced apart from the other at a predetermined distance. The alignment unit (210) of the base plate (200) may be an alignment boss protruded from an upper surface of the base plate (200), for example. Furthermore, the alignment unit (210) of the base plate (200) may be formed in a shape of a circular cylinder, a square cylinder or a polygonal cylinder.

In an exemplary embodiment of the present disclosure, the alignment unit (210) is protruded from a rear surface of the base plate (200) to a front surface (201) opposite to the rear surface and arranged with the circuit board (600). The alignment unit (210) may be formed by a half blanking process stopping a punch of a press machine prior to complete cut-out of the base plate (200) as illustrated in FIG. 8.

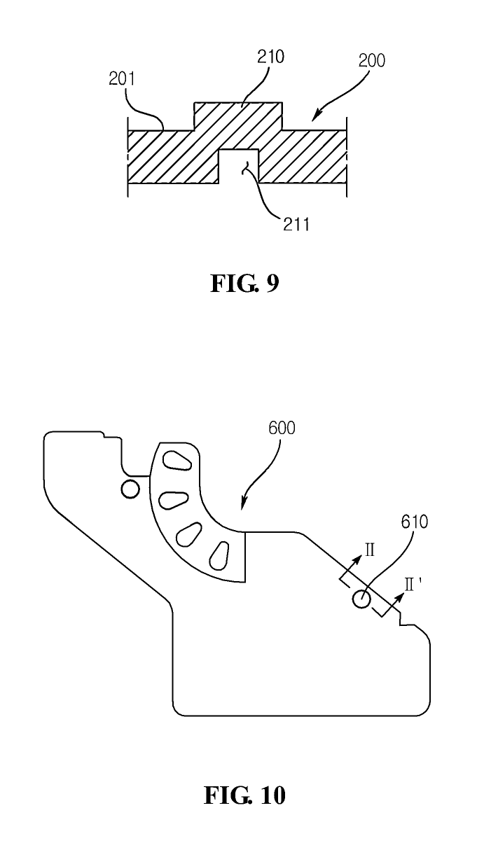

Although the exemplary embodiment of the present disclosure has illustrated and explained that the alignment unit (210) is formed by half blanking process, alternatively, the alignment unit (210) may be formed by a drawing process pressing the punch of the press machine toward the front surface (201) from the rear surface of the base plate (200), as illustrated in FIG. 9.

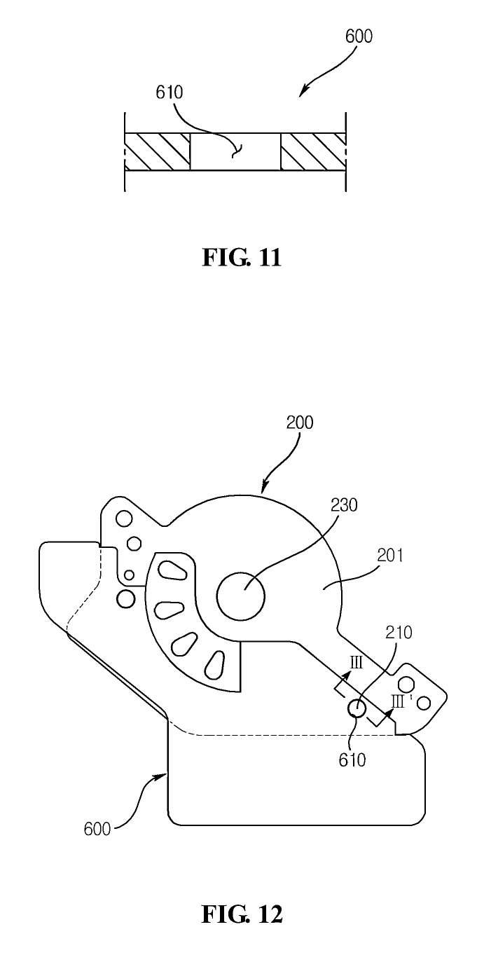

FIG. 10 is a plane view of a circuit board of FIG. 1, and FIG. 11 is a cross-sectional view cut along line ‘II-II’ of FIG. 10.

Referring to FIGS. 10 and 11, the circuit board (600) is formed at an upper surface (201) of the base plate (200), and electrically connected to the coil (330) wound on the core (310) of the stator (300). The circuit board (600) is electrically connected to a flexible circuit board of an ODD mounted with the spindle motor (700), such that the circuit board (600) must be arranged on a designated position of the upper surface (201) of the base plate (200).

In a case the circuit board (600) is not arranged on the designated position of the upper surface (201) of the base plate (200), there may be generated a contact defect with the flexible circuit board of the ODD.

In an exemplary embodiment of the present disclosure, the circuit board (600) is formed with an alignment hole (610) in order to accurately align the circuit board (600) on a designated position of the base plate (200).

The alignment hole (610) may be a through hole passing through an upper surface of the circuit board (600) and a bottom surface opposite to the upper surface of the circuit board (600). Although the exemplary embodiment of the present disclosure has illustrated and explained that the circuit board (600) is formed with an alignment hole (610) passing through the circuit board (600), alternatively, an alignment groove coupled to the alignment unit (210) may be formed at a portion corresponding to the alignment unit (210) of the base plate (200).

The alignment hole (610) of the circuit board (600) is formed at a position corresponding to the alignment unit (210) of the base plate (200), where the alignment hole (610) is formed with a size exactly and correctly insertable into the alignment unit (210) of the base plate (200).

In an exemplary embodiment of the present disclosure, a simple formation of the alignment unit (210) on the base plate (200) and a simple formation of the alignment hole (601) on the circuit board (600) can control an allowance of the alignment unit (210) and the alignment hole (610) to greatly improve a position accuracy of the circuit board relative to the base plate (200) over the conventional prior art.

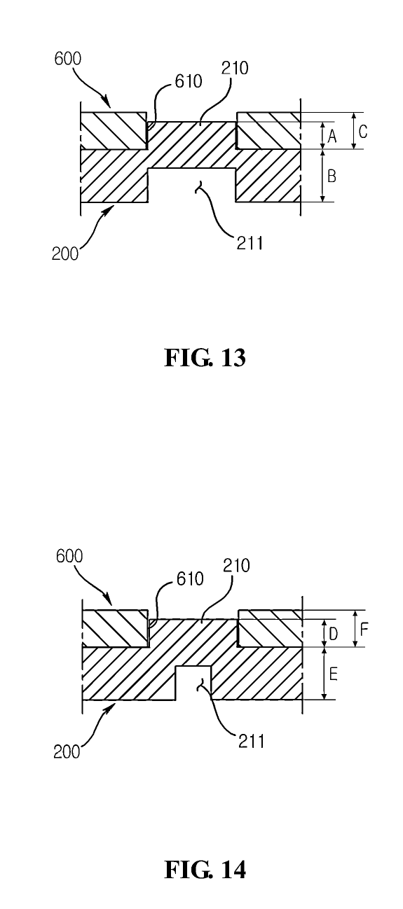

FIG. 12 is a plane view illustrating a base plate and a circuit board of FIG. 1, and FIG. 13 is a cross-sectional view cut along line ‘III-III’ of FIG. 12.

Referring to FIGS. 12 and 13, the base plate (200) is arranged at an upper surface (201) thereof with the circuit board (600), and the alignment hole (610) of the circuit board (600) is coupled to the alignment unit (210) by the half blanking process.

In an exemplary embodiment of the present disclosure, a height (A) of the alignment unit (210) is formed less than 80% of a thickness (B) of the base plate (200) when measured from the upper surface (201) of the base plate (200), which is to allow the alignment unit (210) to be cut from the base plate (200), in a case the height (A) of the alignment unit (210) is more than 80% of the thickness (B) of the base plate (200).

Meanwhile, a height (A) of the alignment unit (210) may be greater than 30% of a thickness (C) of the circuit board (600) when measured from the upper surface (201) of the base plate (200). In a case the height (A) of the alignment unit (210) is formed less than 30% of the thickness (C) of the circuit board (600), coherence between the alignment unit (210) and the circuit board (600) may be weakened to allow the circuit board (600) to be easily separated from the base plate (200). Furthermore, the alignment unit (210) may be arranged on a same planar surface as the upper surface of the circuit board (600), or may be arranged inside the alignment groove (610) formed on the circuit board (600).

FIG. 14 is a cross-sectional view of FIG. 13 according to another exemplary embodiment of the present disclosure.

Referring to FIG. 14, a base plate (200) is arranged at an upper surface (201) with a circuit board (600), and an alignment hole (601) of the circuit board (600) is coupled to an alignment unit (210) formed on the base plate (200) by way of drawing process.

In an exemplary embodiment of the present disclosure, a height (D) of the alignment unit (210) may be less than 80% of a thickness (E) of the base plate (200) when measured from the upper surface (201) of the base plate (200).

Meanwhile, a height (D) of the alignment unit (210) may be greater than 30% of a thickness (F) of the circuit board (600) when measured from the upper surface (201) of the base plate (200).

In a case the height (D) of the alignment unit (210) is less than 30% of a thickness (F) of the circuit board (600), coherence between the alignment unit (210) and the circuit board (600) may be weakened to allow the circuit board (600) to be easily separated from the base plate (200). Furthermore, the alignment unit (210) may be arranged on a same planar surface as the upper surface of the circuit board (600), or may be arranged inside the alignment groove (610) formed on the circuit board (600).

Although the exemplary embodiments of the present disclosure in FIGS. 7 to 14 have illustrated and explained that the alignment unit protruded from the base plate is formed, and the circuit board arranged on the base plate is arranged by being inserted into the alignment unit, alternatively, the base plate may be formed with an alignment hole, and the circuit board may be attached or formed with the alignment unit inserted into the alignment groove.

Referring to FIG. 1 again, the bearing housing (120) fixed to the burring unit (230) of the base plate (200) is coupled by the stator (300). The stator (300) includes a core (310) and a coil (330).

The core (310) is formed by stacking a plurality of thin core pieces radially formed with a plurality of core units at an outer surface with a center opening formed thereon. The opening of the core (310) is press-fitted or coupled to the upper surface of the bearing housing (120). The coil (330) is wound on the core unit of the core (310), and the coil (330) is fixed to an upper surface (201) of the base plate (200).

The rotation shaft (400) is rotatably supported to the bearing (110) of the bearing assembly (100). The rotor (500) is coupled to an outer surface of the rotation shaft (400). The rotor (500) includes a yoke (510) and a magnet (520). The yoke (510) takes a shape of a bottom surface-opened cylinder, and includes a yoke upper plate (512) and a yoke lateral plate (516). A yoke burring unit (514) coupled to the outer surface of the rotation shaft (400) is formed at a rotational center of the yoke upper plate (512). The yoke lateral plate (516) is extended to a direction wrapping the core (310) from an edge of the yoke upper plate (512).

The magnet (520) is arranged along an inner lateral surface of the yoke lateral plate (516), and the magnet (516) is arranged opposite to the core (310). The yoke upper plate (512) is coupled at an upper surface to a centering unit (550) coupled to the yoke burring unit (514), where the centering unit (550) is coupled to an inner surface of the optical disk to align a rotation center of the optical disk to a rotation center of the rotation shaft (400).

As apparent from the foregoing, the spindle motor according to the exemplary embodiments of the present disclosure has an industrial applicability in that an assembly process can be simplified by coupling a circuit board to a base plate, free from a double-sided tape, to obtain reliability in an environmental test, mass production of spindle motors is made possible due to disuse of the double-sided tape, and a warpage (or heave) between the circuit board and the base plate can be inhibited to thereby allow re-using the circuit board.

The spindle motor according to the exemplary embodiments of the present disclosure has another industrial applicability in that the circuit board can be accurately aligned on a designated position of the base plate without a separate jig by forming an alignment unit at an upper surface of the base plate and forming an alignment hole coupled to an alignment unit on the circuit board arranged on an upper surface of the base plate.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A spindle motor, the spindle motor comprising:
a bearing assembly including a bearing housing accommodating a bearing;
a stator coupled to an ambience of the bearing housing;
a rotation shaft rotatably accommodated into the bearing;
a rotor coupled to the rotation shaft to rotate in association with the stator; a base plate coupled to the bearing housing; and
a circuit board arranged at an upper surface of the base plate to be electrically connected to the stator.

2. The spindle motor of claim 1, wherein the base plate is formed with at least one circuit board fixing unit clamping an edge of the circuit board by cutting and bending a part of the base plate.

3. The spindle motor of claim 2, wherein the circuit board fixing unit is arranged on both sides of the bearing assembly based on the bearing assembly.

4. The spindle motor of claim 1, wherein the circuit board fixing unit includes a first fixing unit cut and bent from the base plate and a second fixing unit bent toward an upper surface of the circuit board from the first fixing unit.

5. The spindle motor of claim 4, wherein an angle formed by the first fixing unit and the upper surface of the base plate is an obtuse angle.

6. The spindle motor of claim 5, wherein the second fixing unit is formed in parallel with the upper surface of the circuit board.

7. The spindle motor of claim 4, wherein a gap between the upper surface of the base plate and an upper surface of the second fixing unit is 0.4 mm˜2 mm.

8. The spindle motor of claim 2, wherein the circuit board fixing unit includes a fixing unit cut and bent from the base plate to press a corner joined by the upper surface and a lateral surface of the circuit board.

9. The spindle motor of claim 8, wherein the fixing unit is bent at an angle within 60° towards the circuit board relative to perpendicularity.

10. The spindle motor of claim 1, wherein an insulation member is interposed between the circuit board and the base plate to inhibit an electrical short-circuit between the circuit board and the base plate.

11. The spindle motor of claim 10, wherein the insulation member is any one of paper and a synthetic resin film.

12. The spindle motor of claim 1, wherein the base plate is formed with at least two protrusive alignment units from the upper surface of the base plate, and the circuit board is formed with an alignment hole for inserting the alignment unit.

13. The spindle motor of claim 12, wherein the alignment unit includes an alignment boss protruded from a rear surface of the base plate to the upper surface.

14. The spindle motor of claim 13, wherein the alignment unit is formed by half blanking process.

15. The spindle motor of claim 13, wherein the alignment unit is formed by drawing process.

16. The spindle motor of claim 12, wherein the alignment unit is formed in a shape of a circular cylinder, a square cylinder and a polygonal cylinder.

17. The spindle motor of claim 12, wherein a height of the alignment unit is less than 80% of a thickness of the base plate when measured from the upper surface of the base plate.

18. The spindle motor of claim 12, wherein a height of the alignment unit is greater than 30% of a thickness of the circuit board when measured from the upper surface of the base plate.

19. The spindle motor of claim 1, wherein the stator includes a core and a coil wound on the core, and the rotor includes a yoke coupled to the rotation shaft and a magnet arranged on the yoke opposite to the coil.

20. The spindle motor of claim 1, further comprising a centering unit aligning a rotation center of an optical disk to a rotation center of the rotation shaft by being coupled to the rotation shaft and coupled to an inner surface of the optical disk.
